(19) United States
(12) Patent Application Publication
(10) Pub. No.: US 2012/0189734 A1
(43) Pub. Date: Jul. 26, 2012

(54) Nutritional Composition for Lactating Women

(76) Inventors: Konthirith Tek, Laval (FR); Solenn Kerrand, Laval (FR); Thierry Giordano, Laval (FR)

(21) Appl. No.: 13/386,930

(22) PCT Filed: Jul. 26, 2010
(86) PCT No.: PCT/EP10/60778

§ 371 Date: Apr. 3, 2012

(30) Foreign Application Priority Data
Jul. 29, 2009 (FR) 09/55301

(51) Int. Cl. A23L 1/303; A23L 1/28; A23L 1/304

(52) U.S. Cl. 426/2; 426/73; 426/311

(57) ABSTRACT

The present invention relates to a nutritional composition for women who are breast-feeding a child, including essential nutritional elements for the mother and for the child feeding on the mother's milk, as well as at least one plant extract for promoting breast-feeding. Specifically, the invention relates to a nutritional composition including a protein fraction, a carbohydrate fraction, a lipid fraction including at least one fatty acid of the omega-3 family, at least one mineral element, at least one vitamin including vitamin D and at least one extract of a plant selected from the common hop (Humulus lupulus), barley malt (Hordeum vulgare), fenugreek (Trigonella foenum graecum), anise (Pimpinella anisum), fennel (Foeniculum), cumin (Cuminum cyminum), basil (Ocimum basilicum), white deadnettle (Lamium album), niaouli (Melaleuca quiquenervia), caraway (Carum carvi), heartsease (Viola tricolor), quinoa (Chenopodium quinoa), French lilac (Galega officinalis), or a mixture thereof.

The present invention concerns a nutritional composition for women breast-feeding their child.

During breast-feeding, women have specific requirements for certain nutriments and should, because of this, receive a particular diet. This is because the diet of the women during this period must cover not only her own requirements but also those of the baby.

The requirements of breast-feeding women are either related to deficiencies in certain essential elements observed at the end of pregnancy, or related to the transfer of the nutriments from the mother to the child during breast-feeding, or related to the requirements particular to the physiological and neurological development of the child. For example, at the end of pregnancy deficiencies in certain vitamins are observed, in particular vitamin D. Fatty acids, such as fatty acids in the omega-3 group, in particular docosahexaenoic acid (DHA), are essential to the development of the brain during the foetal period and infancy and should be present in the diet of the mother. The energy requirements, in respect of proteins, lipids and glucids, are very much increased in a woman who is breast-feeding compared with one who is not breast-feeding, some of these nutriments being absorbed by the baby.

Unfortunately women who are breast-feeding do not necessarily find, or do not integrate, what is necessary to fulfil these requirements in their diet. To overcome these problems, it is often necessary to have recourse to nutritional supplements.

Moreover, the breast-feeding of a baby by its mother requires quality in the milk secretion. In women who are breast-feeding, it is sometimes necessary to help the woman to maintain this quality of milk secretions.

Milk secretion is the result of endocrine control exercised mainly by two hormones, prolactin, with regard to the secretion of milk, and oxytocin, with regard to ejection. Insufficiency of milk secretion has many causes, in particular a state of stress and fatigue in the mother. It is known, for example, that the release of ocytocin may be influenced by numerous factors such as stress, the inhibiting role of which is well known. Secretions of prolactin by the pituitary gland may for their part be triggered by suction.

The invention intends to solve all the aforementioned problems.

The aim of the present invention is thus to propose a unique nutritional composition for breast-feeding women that meets both her own nutritional requirements and those of the newborn baby and which in addition assists breast-feeding.

To this end, the invention concerns a nutritional composition comprising a protein fraction, a carbohydrate fraction, a lipid fraction including at least one fatty acid of the omega-3 family, at least one mineral element, at least one vitamin including vitamin D and at least one extract of a plant selected from the common hop (Humulus lupulus), barley malt (Hordeum vulgare), fenugreek (Trigonella foenum graecum), anise (Pimpinella anisum), fennel (Foeniculum), cumin (Cuminum cyminum), basil (Ocimum basilicum), white deadnettle (Lamium album), niaouli (Melaleuca quiquenervia), caraway (Carum carvi), heartsease (Viola tricolor), quinoa (Chenopodium quinoa), French lilac (Galega officinalis), or a mixture thereof.

Plants are today very often associated with human or animal diet because of the numerous benefits thereof. They have in fact advantageous physiological properties in humans or animals and the use thereof in nutritional compositions, food supplements or pharmaceutical compositions is now well accepted.

Plants belonging to the group formed by the common hop, barley malt, fenugreek, anise, fennel, cumin, basil, white deadnettle, niaouli, caraway, heartsease, quinoa and French lilac have an activity promoting lactation in women, that is to say promoting the initiation, production and maintenance of the secretion of milk and more generally assisting breast-feeding. By way of example, barley is traditionally used for stimulating the secretion of prolactin and thus assisting lactation. Anise has an “oestrogen-like” activity, that is to say it exerts a hormonal function similar to that of oestrogens, which fulfil a role during the initiation of lactation. Consequently, these plants have advantageous galactogogue properties that stimulate the secretion of milk.

The composition according to the invention thus contains proteins, lipids and glucids as well as vitamins and minerals that are necessary to the requirements of breast-feeding women and to babies feeding on their milk. They have the additional advantage of containing one or more extracts of plants promoting lactation and, more generally, assisting breast-feeding. This composition is thus perfectly suited to the condition of women in a breast-feeding period.

The protein fraction may be of varied origin. It may be a case of proteins of animal, vegetable or dairy origin or a mixture thereof. The protein source may for example consist of whole, semi-skimmed or skimmed milk in liquid form or in the form of a concentrate.

The lipid fraction may be any fraction normally use for preparing baby formula. It may be obtained from oil or vegetable, animal or dairy fat, from eggs or from fish oil. Likewise, any source of glucids can be envisaged.

The composition according to the invention includes in its lipid fraction at least one so-called essential fatty acid from the omega-3 group. Fatty acids in the omega-3 group are for example eicosapentaenoic acid (EPA), docosahexaenoic acid (DHA) alpha linoleic acid (ALA), and fatty acids in the omega-6 group are for example linoleic acid (LA) and arachidonic (AA). A combination of one or several fatty acids belonging to the omega-3 and omega-6 groups is also envisaged according to the invention. These essential fatty acids, in particular omega-3, are essential to the growth and development of the brain during the neonatal period.

According to a preferred embodiment of the invention, the fatty acid in the omega-3 group in the lipid fraction is docosahexaenoic acid or DHA.

Vitamin D is important in the composition according to the invention since it overcomes the deficiencies in women at the end of pregnancy and also participates in fixing calcium on the bones of the skeleton of the newborn baby. It is added in a natural form such as ergocalciferol or cholecalciferol.

The compound or compounds chosen from the other vitamins and minerals may for example be, with regard to vitamins, vitamin A, vitamin B1, vitamin B2, vitamin B3, vitamin B6, vitamin B9, vitamin B12, vitamin E and vitamin C, and with regard to minerals, selenium, calcium, phosphorus, iodine, magnesium and zinc.

The vitamins and minerals are used in the compositions in proportions recommended for breast-feeding women.

According to one embodiment of the invention, the composition comprises iodine, selenium and magnesium.

Some of the iodine present in the diet of the mother is absorbed by the baby via the maternal milk. The composition according to the invention meets the requirements of the mother and child. Iodine is present in the composition mainly in the form of potassium iodide or any other authorised form.

Selenium is provided in the form of selenite or any other authorised form.

Magnesium is provided in the form of magnesium chloride or any other authorised form.

According to one embodiment of the invention, the composition comprises a milk base, preferentially chosen from full-cream, semi-skimmed or skimmed milk in liquid form or in the form of a concentrate.

The milk product, among other things, provides calcium in the diet of the mother, which participates in the construction of the skeleton of the newborn baby.

Preferentially, the milk is in a liquid form. This embodiment advantageously makes it possible to partly cover the water intakes of the breast-feeding women, as strongly recommended by the medical profession.

According to this particular embodiment, the extracts of plants, lipids, glucids, minerals and vitamins are added during the process of manufacturing the consumable milk between the standardisation and sterilisation steps, as the following examples will illustrate.

Although all the aforementioned plant extract combinations are envisaged in the present invention, according to a preferred embodiment this comprises a plant extract of barley malt, an extract of fenugreek and an extract of anise.

This combination of plant extracts in the composition is particularly advantageous. This is because barley malt has the advantage of stimulating the secretion of prolactin, anise has an oestrogenic activity and finally fenugreek favourably modifies the taste of the milk produced by the woman and thus stimulates suction. The plant extracts then exert a synergy effect assisting breast-feeding by initiating, stimulating and maintaining the lactation phenomenon.

According to another preferred embodiment of the invention, the composition comprises a plant extract of barley malt and an extract of fenugreek or an extract of barley malt and an extract of anise or an extract of fenugreek and an extract of anise.

In one embodiment of the invention, the composition comprises a fibre source, preferably chosen from galactofructose and/or fructooligosaccharides. The purpose of the fibres is to assist the functioning of the intestinal transit in the woman. In addition galactofructose and fructooligosaccharides are prebiotic compounds that stimulate the growth and metabolic activity of non-pathogenic bacteria in the intestinal flora.

According a preferred embodiment of the invention, the nutritional composition provides daily:

between 0.1 μg and 10 μg, in particular between 1 and 2 μg, of vitamin D,

between 100 mg and 1 mg, in particular between 200 and 300 mg, of calcium,

between 1 μg and 100 μg, in particular between 10 and 30 μg, of selenium,

between 10 μg and 200 μg, in particular between 30 and 60 μg, of iodine,

between 10 mg and 400 mg, in particular between 110 and 130 mg, of magnesium,

between 100 mg and 1000 mg, in particular between 230 and 250 mg, of phosphorus,

between 0.1 mg et 30 mg of fibres,

between 10 mg and 500 mg, in particular between 50 and 150 mg, of docosahexaenoic acid,

between 0.01 g and 2 g of long-chain polyunsaturated fatty acids,

between 10 mg and 6000 mg of at least one plant extract chosen from the common hop (Humulus lupulus), barley malt (Hordeum vulgare), fenugreek (Trigonella foenum graecum), anise (Pimpinella anisum), fennel (Foeniculum), cumin (Cuminum cyminum), basil (Ocimum basilicum), white deadnettle (Lamium album), niaouli (Melaleuca quiquenervia), caraway (Carum carvi), heartsease (Viola tricolor), quinoa (Chenopodium quinoa), French lilac (Galega officinalis), or a mixture thereof.

In such a composition, the lipids represent 20% to 40% of the calorific supply of the composition, the proteins represent 10% to 30% of the calorific supply of the composition and the glucids represent 40% to 60% of the calorific supply of the composition.

The daily supply may for example be achieved by means of a single formulation of 100 ml, 200 ml or more. This supply may also be distributed in several doses over a day.

According to a particular embodiment of the invention, the composition provides daily:

from 10 to 300 mg, in particular between 170 and 210 mg, of barley malt,

from 50 to 2000 mg, in particular between 50 and 150 mg, of fenugreek,

from 100 to 4000 mg, in particular between 100 and 200 mg, of anise.

Advantageously, the composition is in the form of a liquid, a powder, a solid or semi-solid food, a tablet, a granule, a solution contained in an ampoule or any other suitable galenic form.

The invention also concerns a composition as defined above for use thereof as a medication.

The invention also concerns a composition as defined above for assisting breast-feeding, in particular for stimulating and/or initiating lactation and/or stimulating suction during breast-feeding in a mammal, in particular in humans, or the use of a composition as defined above for preparing a product intended to promote breast-feeding, in particular stimulating and/or initiating lactation and/or stimulating suction during breast-feeding in mammals, in particular in humans.

Finally, the invention concerns a method for assisting breast-feeding, in particular for stimulating and/or initiating lactation and/or stimulating suction by a baby during breast-feeding, comprising the administration to a breast-feeding woman of a composition as defined above in a mammal, in particular in humans.

The composition is generally ingested once a day, preferentially in the form of a single dose.

The invention is illustrated in the following examples, which are intended to be illustrative and non-limitative.

Nutritional composition for a breast-feeding woman in the form of a liquid milk ready to be consumed:
Quantity/100 ml reconstituted:
Vitamin D: 0.75 μg
Calcium: 120 mg
Selenium: 8.25 μg
Iodine: 22.5 μg
Magnesium: 56.25 mg
Phosphorus: 120 mg
Fibres: 0.1 g
Galactofructose: 1.26 g
Lipids: 1.9 g
Including DHA: 40 mg
Proteins: 3.9 g
Glucids: 6.4 g
including sugars: 6.4 g
Barley malt from 0.01 to 0.1 g
Fenugreek 0.01 to 0.1 g
Anise 0.01 to 0.1 g

Preparation:
Standardisation of UHT sterilised milk: skimming of the milk according to the type of milk sought: full-cream milk (35 g/l of fat); semi-skimmed milk (15-18 g/l of fat); skimmed milk (maximum 3 g/l of fat);
addition of vitamins, minerals, fibres, omega-3 and plant extracts;
preheating to 70°-75° C.;
homogenisation;
sterilisation (135°-150° C. for 2 to 6 seconds) by indirect heating on a tubular exchanger;
cooling;
packaging under aseptic atmosphere and sterile packs.

1-14. (canceled)

15. A nutritional composition comprising:
a protein fraction,
a glucid fraction,
a lipid fraction comprising at least one fatty acid in the omega-3 group,
at least one mineral element,
at least one vitamin including vitamin D,
at least one plant extract chosen from common hop, barley malt, fenugreek, anise, fennel, cumin, basil, white deadnettle, niaouli, caraway, heartsease, quinoa, French lilac or a mixture thereof.

16. The nutritional composition according to claim 1, further comprising a milk base comprising a liquid milk or a dried milk concentrate.

17. The nutritional composition according to claim 1, wherein the at least one plant extract is an extract of barley malt plant, fenugreek and anise.

18. The nutritional composition according to claim 1, wherein the at least one plant extract is an extract of barley malt plant and fenugreek or barley malt and anise or fenugreek and anise.

19. The nutritional composition according to claim 1, wherein the fatty acid in the omega-3 group comprises docosahexaenoic acid or DHA.

20. The nutritional composition according to claim 1, further comprising iodine, selenium and magnesium among the at least one mineral element.

21. The nutritional composition according to claim 1 further comprising a source of fibres, preferentially chosen from galactofructose and/or fructooligosaccharide.

22. The nutritional composition according to claim 1, wherein a dose of a the nutritional composition is formed by:
Vitamin D: from 0.1 μg to 10 μg, in particular 1 to 2 μg,
Calcium: 100 mg to 1 g, in particular 200 to 300 mg,
Selenium: from 1 to 100 μg, in particular 10 to 30 μg,
Iodine: 10 to 200 μg, in particular 30 to 60 μg,
Magnesium: 10 to 400 mg, in particular 110 to 130 mg,
Phosphorus: 100 to 1000 mg, in particular 230 to 250 mg,
Fibres: 0.1 to 30 mg,
Docosahexaenoic acid: 10 to 500 mg, in particular 50 to 150 mg,
Long-chain polyunsaturated fatty acids: 0.01 to 2 g,
between 10 and 6000 mg of at least one plant extract chosen from the common hop (Humulus lupulus), barley malt (Hordeum vulgare), fenugreek (Trigonella foenum graecum), anise (Pimpinella anisum), fennel (Foeniculum), cumin (Cuminum cyminum), basil (Ocimum basilicum), white deadnettle (Lamium album), niaouli (Melaleuca quiquenervia), caraway (Carum carvi), heartsease (Viola tricolor), quinoa (Chenopodium quinoa), French lilac (Galega officinalis), or a mixture thereof.

23. The nutritional composition according to claim 8, wherein the dose further comprises between 10 and 300 mg of barley malt, between 50 and 2000 mg of fenugreek, and between 100 and 4000 mg of anise.

24. The nutritional composition according to claim 8, wherein the dose further comprises between 170 and 210 mg of barley malt, between 50 and 150 mg of fenugreek, and between 100 and 200 mg of anise.

25. The nutritional composition according to claim 1, wherein the nutritional composition is in galenic form such that the galenic form is one of a liquid, a powder, a food, a tablet, a granule, or a solution contained in an ampoule.

26. The nutritional composition according to claim 1, wherein the nutritional composition is used as a medication.

27. A method for assisting breast-feeding, in particular for stimulating and/or initiating lactation and/or stimulating suction by a baby during breast-feeding, comprising:
administrating, to a breast-feeding woman, a composition comprising:
a protein fraction,
a glucid fraction,
a lipid fraction comprising at least one fatty acid in the omega-3 group,
at least one mineral element,
at least one vitamin including vitamin D,
at least one plant extract chosen from common hop, barley malt, fenugreek, anise, fennel, cumin, basil, white deadnettle, niaouli, caraway, heartsease, quinoa, French lilac or a mixture thereof.

28. A method for preparing a product intended to stimulate and/or initiate lactation or to stimulate suction during breast-feeding in a mammal, in particular in humans, the method comprising:
forming a dose of a nutritional composition, wherein a dose of a the nutritional composition, the nutritional composition comprising:
Vitamin D: from 0.1 μg to 10 μg, in particular 1 to 2 μg,
Calcium: 100 mg to 1 g, in particular 200 to 300 mg,
Selenium: from 1 to 100 μg, in particular 10 to 30 μg,
Iodine: 10 to 200 μg, in particular 30 to 60 μg,
Magnesium: 10 to 400 mg, in particular 110 to 130 mg,
Phosphorus: 100 to 1000 mg, in particular 230 to 250 mg,
Fibres: 0.1 to 30 mg,
Docosahexaenoic acid: 10 to 500 mg, in particular 50 to 150 mg,
Long-chain polyunsaturated fatty acids: 0.01 to 2 g,
between 10 and 6000 mg of at least one plant extract chosen from the common hop (Humulus lupulus), barley malt (Hordeum vulgare), fenugreek (Trigonella foenum graecum), anise (Pimpinella anisum), fennel (Foeniculum), cumin (Cuminum cyminum), basil (Ocimum basilicum), white deadnettle (Lamium album), niaouli (Melaleuca quiquenervia), caraway (Carum carvi), heartsease (Viola tricolor), quinoa (Chenopodium quinoa), French lilac (Galega officinalis), or a mixture thereof.
